(19) United States
(12) Patent Application Publication
(10) Pub. No.: US 2012/0067460 A1
(43) Pub. Date: Mar. 22, 2012

(54) LOG SPLITTER

(76) Inventor: Charlie Valdez, Selma, OR (US)

(21) Appl. No.: 13/246,555

(22) Filed: Sep. 27, 2011

Related U.S. Application Data
(63) Continuation-in-part of application No. 12/541,845, filed on Aug. 14, 2009, now abandoned.

(51) Int. Cl. B27L 7/06

(52) U.S. Cl. 144/195.8

(57) ABSTRACT

Log splitters are disclosed herein. An embodiment of a log splitter includes a first port having a circumference wherein at least one blade is located on the circumference. There is at least one blade located exterior to the first port, wherein a portion of the log not passing through the first port is split by the blade. The splitter includes a second stage having a second port with at least one blade located on the circumference. In addition, there is at least one blade located exterior to the second port, wherein a portion of the log not passing through the second port is split by the blade.

This application is a continuation in part of U.S. patent application Ser. No. 12/541,845 of Charlie Valdez filed on Aug. 14, 2009 for LOG SPLITTER, which is incorporated for all that is disclosed therein.

### BACKGROUND

Wood provides an efficient fuel for heat. However, logs need to be split in order to burned efficiently. A split log is able to dry and provides a better surface for burning. Log splitting can be very difficult. For example, knots in the logs and trees with twisted grains do not split well using many conventional splitting methods.

### BRIEF DESCRIPTION OF THE DRAWINGS

FIG. 1 is a top isometric view of an embodiment of a log splitter.

FIG. 2 is a isometric view of the first stage of the log splitter of FIG. 1.

FIG. 3 is a isometric view of the second stage of the log splitter of FIG. 1.

FIG. 4 is a front isometric view of another embodiment of a splitter.

FIG. 5 is a rear isometric view of the splitter of FIG. 4.

FIG. 6 is a front elevation view of the splitter of FIG. 4.

FIG. 7 is a rear isometric view of the splitter of FIG. 4 with several components removed for illustration purposes.

### DETAILED DESCRIPTION

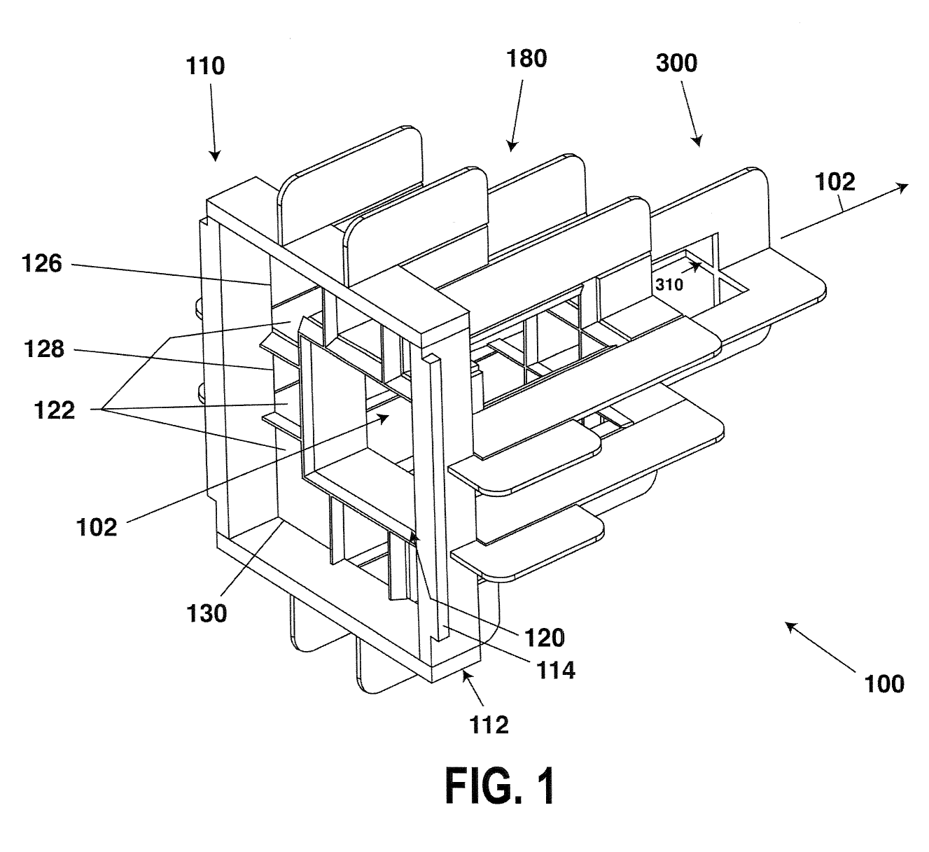

A top perspective view of a log splitter 100 is shown in FIG. 1. As described in greater detail below, the log splitter 100 has a plurality of stages that split a log as the log is forced through the log splitter 100. Logs are forced in a direction 102 through the log splitter 100. The logs get split into smaller and smaller portions as they are forced through the stages. It is noted that other components that serve to force the log through the log splitter 100 may be included or associated with the log splitter, but they are not shown in FIG. 1. For example, a hydraulic ram or the like may force logs through the log splitter 100.

Reference is made to a first stage 110 of the log splitter 100. The first stage 110 includes a frame 112 which may serve to support other components of the log splitter 100. The frame 112 may also have a lip 114 which may secure the log splitter 100 in a fixed position. For example, the lip 114 may serve to maintain the log splitter 100 in a fixed position as logs are forced through the stages. The frame 112 forms an opening in which logs are passed. The opening in the frame is sometimes referred to as the opening.

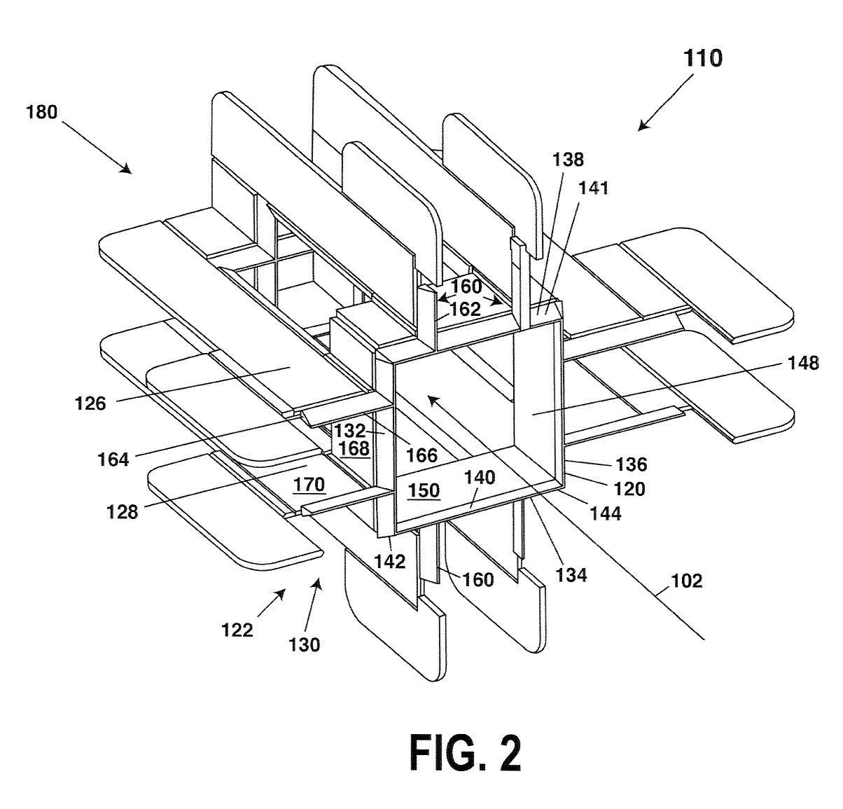

As described in greater detail below, the first stage 110 has a plurality of ports wherein the boundaries of the ports serve to cut or split logs. FIG. 2 is a view of the first stage 110 with the frame 112 removed. As shown, the first stage 110 has a first port 120, which may be located substantially in the center of the first stage 110. The first port 120 is shown as being substantially square. However, the first port may be virtually an shape. A plurality of secondary ports 122 are located around the periphery of the first port 120. Three secondary ports are described and identified individually as the first secondary port 126, the second secondary port 128, and the third secondary port 130. As logs are passed through the first stage 110, the first port 120 causes the center of the log to be split to an elongated square shape. The secondary ports 122 split the remaining portions of the log. The first port 120 and the secondary ports 122 are sometimes referred to as having first sides and second sides, wherein logs enter the first sides and exit the second sides.

The first port 120 has a plurality of blades 131 located around its periphery. The blades 131 described herein are referred to individually as the first blade 132, the second blade 134, the third blade 136, and the fourth blade 138. Referring to the second blade 134, which illustrative of all the blades 131, the second blade 134 has a first surface 140, a second surface 142, and an edge 144. The first surface 140 and the second surface 142 are on different planes that intersect, which forms the edge 144. The edge 144 serves to split the logs as described herein. The configuration of the first surface 140 and the second surface 142 cause the second blade 134 to be tapered, which forces portions of the logs into the secondary ports 122.

As described above, logs pass through the log splitter 100 and the first stage 110 in a direction 102 from the first surface to the second surface. The above described plane of the first surface 140 of the second blade 134 may be substantially parallel to the direction 102. Thus, the second blade 134 and the remaining blades 131 taper via the second surface 142. The second surface 142, or taper, causes portions of the log that are split by the second blade 134 to pass through the secondary ports 122.

The first port 120 has interior surfaces 148 that define the first port 120. Reference is made to a second interior surface 150 that is similar to all the interior surfaces 148. In addition, reference is made to the relation between the second interior surface 148 and the second blade 140, which is similar to the relation to all the blades 131 and their corresponding interior surfaces 148. The plane of the first surface 140 of the second blade 134 may be located on a different plane as the second interior surface 150. However, the planes may be substantially parallel. This location of the second blade 134 relative to the second interior surface 150 causes the first surface 140 of the second blade 134 to be offset from the second interior surface. Thus, circumference of the first port defined by the interior surfaces 148 may be greater than the circumference of the opening defined by the first surfaces 140 of the blades 131. Therefore, when a log is forced through the first stage 110, it is split by the blades 131 and continues to pass through the first stage 110. Because the interior circumference is greater than the exterior circumference (circumference of the blades 131), the log has a reduced chance of jamming as is passes through the first stage 110.

As shown in FIG. 2, the secondary ports 122 are at least partially surrounded by secondary blades 160. The first secondary port 126 is closed on two sides and has a first secondary blade 162 and a second secondary blade 164 located on the closed sides. The first secondary port 126 has a corner that is the intersection of the first blade 132 and the fourth blade 138. It is noted that the configuration of the first secondary port 126 is substantially similar to the remaining secondary ports located on the corners of the first stage 110. The blades 162, 164 are tapered in a direction to force sections of the log to be diverted away from the first stage 110. The taper is sometimes referred to as being in or toward the secondary port 126. This diversion occurs because the first secondary port 122 only has two sides, so log portions cannot get stuck therein.

The second secondary port 126 is similar to the secondary ports located on the side of the first port 120. The second secondary port 126 has three interior surfaces, which are referred to as the first interior surface 166, the second interior surface 168, and the third interior surface 170. The first interior surface 166 is associated with the second secondary blade 164 and the third interior 170 surface is associated with a third secondary blade 174. The second interior surface 168 is associated with the first blade 132 of the first port 120.

The first blade 132 is tapered as described above to force a portion of a log into the second secondary port 128. The portion of the log forced through the second secondary port 128 is split by the second secondary blade 164 and the third secondary blade 174. It is noted that the first surfaces 140 of the secondary blades 164, 174 are offset from their respective interior surfaces 166, 170. As with the first port 120, the offset reduces the likelihood that logs will get stuck in the second secondary port 128 and the similar secondary ports.

Having described the first stage 110, the second stage 180 of the log splitter will now be described. The second stage receives the portion of the log that has passed through the first port 120. In the embodiment of FIGS. 1 and 2, the log entering the second stage 180 will be substantially square. For example, the log may be fourteen inches on each side, but may have a longer length. In some embodiments, the second stage 180 is a substantially similar, but smaller version of the first stage 110.

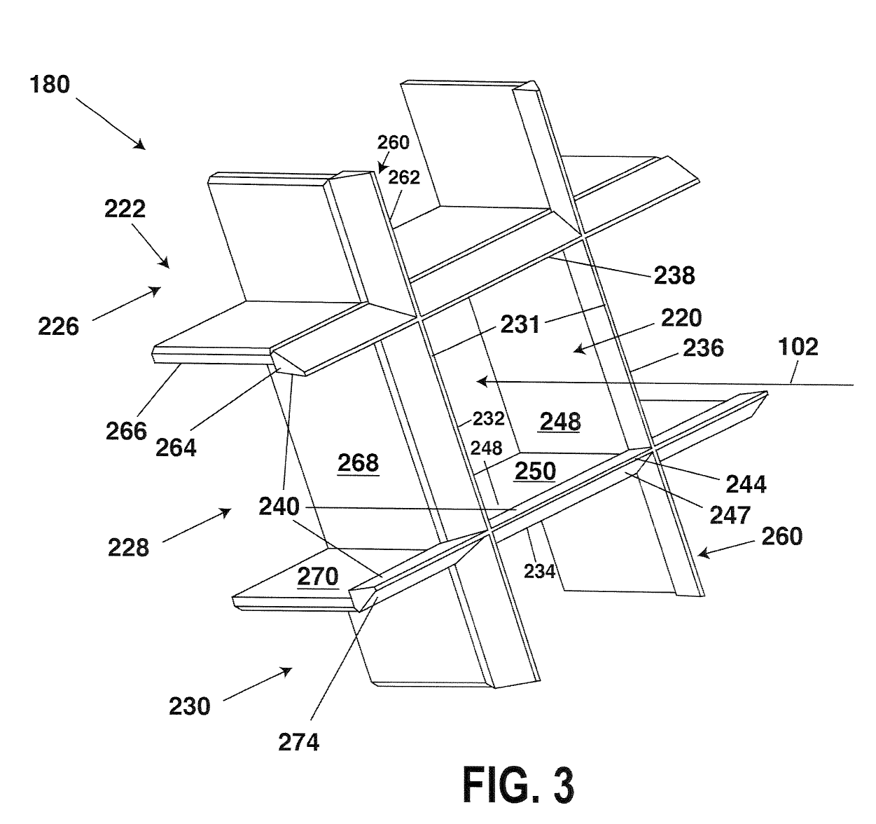

With additional reference to FIG. 3, the second stage 180 may have a second port 220 that may be half the size of the first port 120. For example, the second port 220 may be seven inches by seven inches. The second port 220 is shown as being substantially square. However, the second port 220 may be virtually an shape. A plurality of secondary ports 222 are located around the periphery of the second port 220. The second port 220 and the secondary ports 222 have first and second sides wherein logs enter the first sides and exit the second sides. Three secondary ports 222 are described and identified individually as the first secondary port 226, the second secondary port 228, and the third secondary port 230. As logs are passed through the second stage 180, the second port 220 causes the center of the log to be split to an elongated square shape. The secondary ports 122 split the remaining portions of the log. It is noted that the second stage 180 may be the same size as the opening of the first port 120, which may be approximately fourteen by fourteen inches.

The second port 220 has a plurality of blades 231 located around its periphery, which are substantially similar or identical to the blades 131. The blades 231 described herein are referred to individually as the first blade 232, the second blade 234, the third blade 236, and the fourth blade 238. Referring to the second blade 234, which illustrative of all the blades 231, the second blade 234 has a first surface 240, a second surface 242, and an edge 244. The first surface 240 and the second surface 242 are on different planes that intersect, which forms the edge 244. The edge 244 serves to split the logs as described herein.

As described above, logs pass through the log splitter 100 and the second stage 180 in a direction 102. The above described plane of the first surface 240 of the second blade 234 may be substantially parallel to the direction 202. Thus, the second blade 234 and the remaining blades 231 taper via the second surface 242. The second surface 242 causes portions of the log that are split by the second blade 234 to pass through the secondary ports 222. It is noted that the blades 231 associated with the second port 220 function substantially similar to the blades 131 of the first port 120.

The second port 220 has interior surfaces 248 that define the second port 220. Reference is made to a second interior surface 250 that is similar to all the interior surfaces 248. In addition, reference is made to the relation between the second interior surface 248 and the second blade 234, which is similar to the relation to all the blades 231 and their corresponding interior surfaces 248. The plane of the first surface 240 of the second blade 234 may be located on a different plane as the second interior surface 250. However, the planes may be substantially parallel. This location of the second blade 234 relative to the second interior surface 250 causes the first surface 240 of the second blade 234 to be offset from the second interior surface. Thus, circumference of the first port 220 defined by the interior surfaces 248 may be greater than the circumference of the opening defined by the first surfaces 240 of the blades 231. Therefore, when a log is forced through the second stage 180, it is split by the blades 231 and continues to pass through the second stage 180. Because the interior circumference is greater than the exterior circumference (circumference of the blades 231), the log has a reduced chance of jamming as is passes through the second stage 180.

As shown in FIG. 3, the secondary ports 222 are at least partially surrounded by secondary blades 260. The first secondary port 226 is closed on two sides by a first secondary blade 262 and a second secondary blade 264. It is noted that the configuration of the first secondary port 226 is substantially similar to the remaining secondary ports located on the corners of the second stage 180. The blades 262, 264 are tapered in a direction to force sections of the log to be diverted away from the second stage 180. This diversion occurs because the first secondary port 226 only has two sides, so log portions cannot get stuck therein.

The second secondary port 226 is similar to the secondary ports located on the side of the second port 220. It is also similar to the side secondary ports on the first stage 110. The second secondary port 226 has three interior surfaces, which are referred to as the first interior surface 266, the second interior surface 268, and the third interior surface 270. The first interior surface 266 is associated with the second secondary blade 264 and the third interior 270 surface is associated with a third secondary blade 274. The second secondary blade 264 may be an extension of the fourth blade 238 and may be tapered in the same direction as the fourth blade 238. The third secondary blade 274 may be an extension of the second blade 234 and may be tapered in the same direction as the second blade 234. The second interior surface 268 is associated with the first blade 232 of the second port 220.

The first blade 232 is tapered as described above to force a portion of a log into the second secondary port 228. The portion of the log forced through the second secondary port 228 is split by the second secondary blade 264 and the third secondary blade 274. It is noted that the first surfaces 240 of the secondary blades 264, 274 are offset from their respective interior surfaces 266, 270. As with the second port 220, the offset reduces the likelihood that logs will get stuck in the second secondary port 228 and the similar secondary ports. The log splitter 100 described herein has a third stage 300 that further splits logs that have passed through the second stage 180. The third stage has four blades 310 that split the log into quarters. The log portions are then discharged from the splitter 100, so the blades 310 do not need to be tapered.

Having described the components of the splitter 100, its operation will now be disclosed. Referring to FIG. 1, the frame 112 is supported relative to a mechanism, such as a hydraulic piston that forces logs through the splitter 100. A log is placed against the first stage 110. The above-described mechanism then forces the log through the first stage 110.

If the log is large enough to contact all nine ports of the first stage 110, it will be split into nine portions. The portion passing through the first port 110 will be substantially square and will pass through to the second stage 180. The portions of the log that pass through the secondary ports 122 will be discharged or may fall away from the splitter 100. The blades 131 on the first port 120 are tapered, so as to cause the log portions being split to pass into the secondary ports 122. The space between the blades 131 and the interior surfaces 148 of the first port 120 causes the portion of the log passing through the first port 120 to be slightly smaller than the first port 120. This size difference prevents the log portion passing through the first port 120 from getting stuck therein.

At this point, the original log has been split to a center portion that passed through the first port 120 and eight other portions that passed through the secondary ports 122. The center section is then passed through the second stage 180. The second stage 180 is approximately the size of the first port 120. The log is split again into a center portion that passes through the second port 220 and eight other portions that pass through the secondary ports 222. The center portion is then passed through the third stage 300 where it is spit again. In the embodiment described above, the third stage 300 splits the log into quarters. However, the third stage 300 could split the log into halves or thirds.

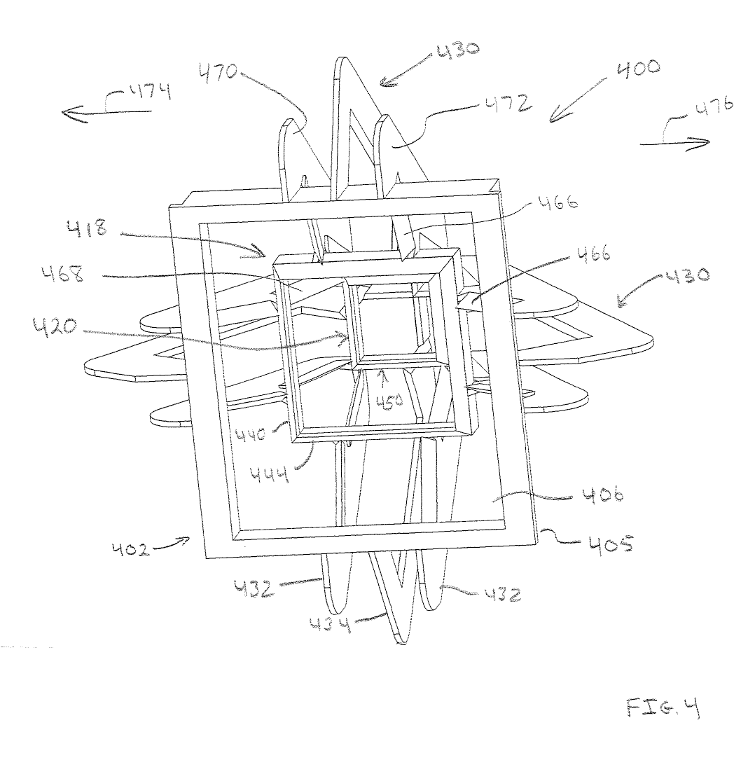

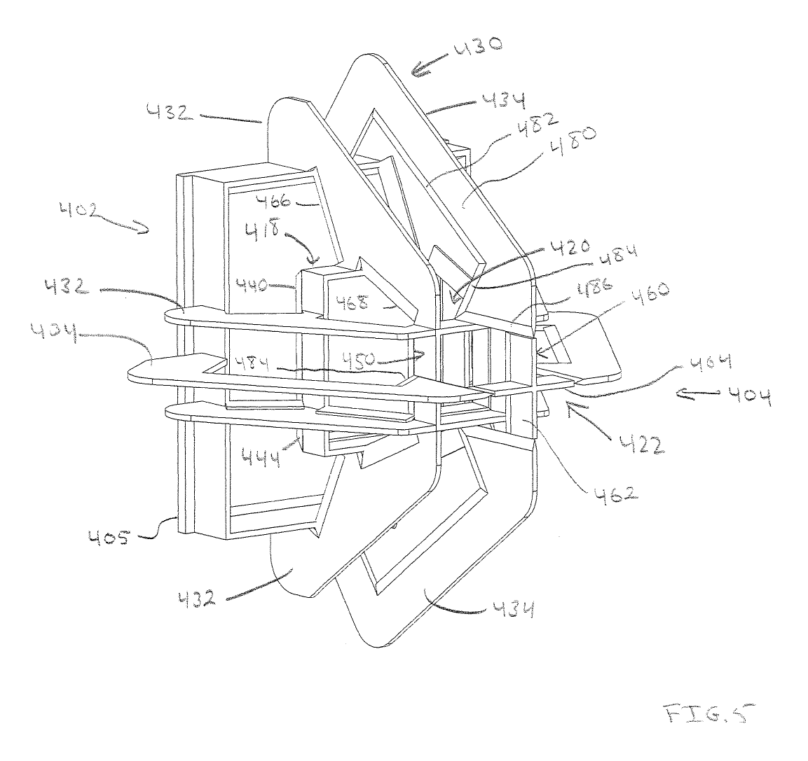

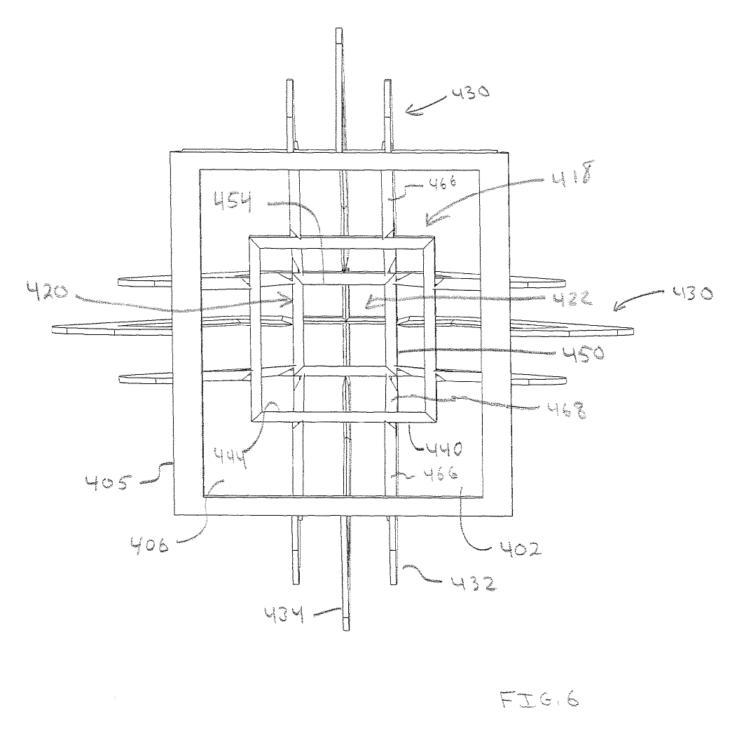

Another embodiment of a log splitter 400 is shown in FIG. 4, which is a front isometric view of the log splitter 400. A rear isometric view of the splitter 400 is shown in FIG. 5. A front elevation view of the splitter 400 is shown in FIG. 6. As described in greater detail below, the splitter 400 has a plurality of stages that split logs as the logs are forced through the splitter 400.

The splitter 400 has a first end 402 and a second end 404 wherein logs enter the first end 402 and exit the second end. The first end 402 is sometimes referred to as the entrance and the second end 404 is sometimes referred to as the exit. The logs are split as they pass through the splitter 400. The first end 404 includes a frame 405 that provides an opening 406. The frame 405 also provides a support structure for other components of the splitter 400 as described in greater detail below. As shown in the figures, the perimeter of the frame 405 defines the boundary of the opening 406. During the splitting process, logs first pass through the opening 406. In some embodiments, the frame 405 may have blades along the perimeter that perform a first split on the logs as they pass through the opening 406. In the embodiments described below, the frame 405 does not include these blades.

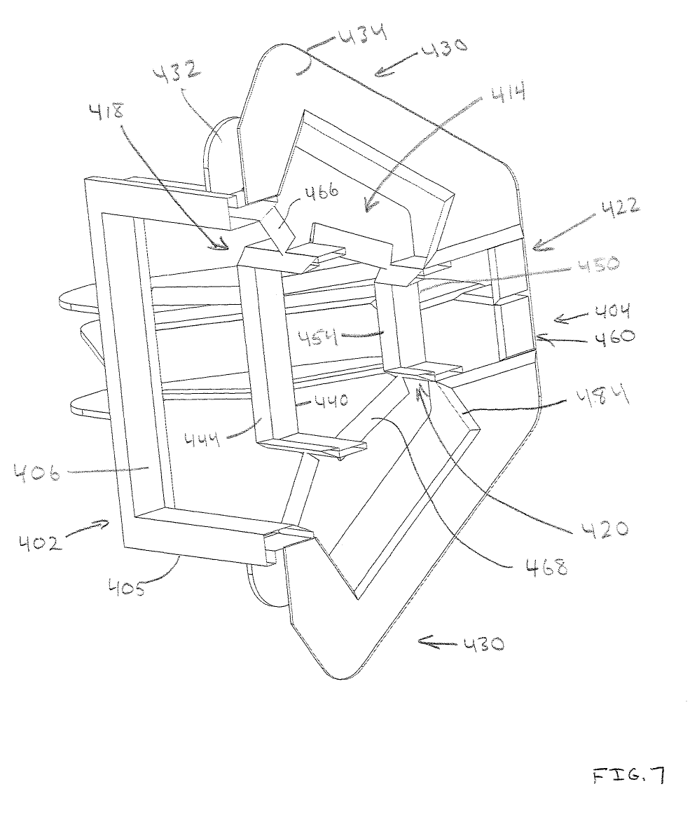

A front isometric, cut-away view of an embodiment of the splitter 400 is shown in FIG. 7. As shown in FIG. 7, the splitter 400 has a plurality of splitting stages 414 located behind the frame 405. The splitting stages 414 serve to split the logs as they are forced through the splitter 400 as described below. The splitter 400 is shown as having three splitting stages 414, however, the splitter 400 may have any number of splitting stages. The three splitting stages 414 are referred to individually as the first stage 418, the second stage 420, and the third stages 422.

The stages 414 include blades that are fixed to a position by a plurality of support members 430. In the embodiment of the splitter 400 described herein, there are two types of support members 430, first support members 432 and second support members 434. The first support members 432 primarily support the first stage 418 and the second stage 420. The second support members 434 primarily support the third stage 422.

The first stage 418 includes a first port 440 that is affixed to the frame 405 by the first support members 432. The first port 440 in the embodiments described herein is substantially square. In other embodiments, the first port 440 could have other shapes, such as rectangular or triangular. A blade 444 extends around the perimeter of the first port 440. The blade 444 splits a log as it passes through the first port 440. Parts of the log that do not pass through the first port 440 are split by blades on the support members 430 as described below. The part of the log that passes through the first port 440 has a size and shape that is the same as the perimeter of the first port 440.

The blade 444 on the first port 440 is tapered toward the exterior of the splitter 400. The tapering causes portions of the log that do not pass through the first port 440 to be forced from the splitter 400. By doing so, these portions are split by the other blades and removed from the splitter 400. Accordingly, less force is required to force the logs through the splitter 400.

The second stage 420 has a second port 450. As with the first port 440, the second port 450 is substantially square. However, the second port 450 may be any other shape that will cause logs to split when passed therethrough. The second port 450 also has a blade 454 extending around the perimeter. The blade 454 may be tapered in order to force split portions of the log away from the splitter 400. Thus, a section of the log having a size and shape of the second port 450 passes through the second port 450. The remaining portions of the log are split away.

As shown in FIG. 5, the second port 450 may be supported to the frame 405 by way of the first support members 432 and/or the second support members 434. In some embodiments, the second port 450 is formed using the first support members 432 and is not a separate component of the splitter 400. For example, a first support member 432 may extend from the top of the frame 405 to the bottom of the frame 405. The portion of the first support member 432 located toward the second end 404 of the splitter 400 may be formed into a section of the second port 450.

The third stage 422 does not necessarily have a port, but has splitting blades 460. In the embodiment described herein, the splitting blades are two blades, a first blade 462 and a second blade 464. The portion of the log that passes through the second port 450 is split by the splitting blades 460. The blades 462, 464 form a cross. However, the blades 462, 464 may form any number of other shapes and there may be more or less than two splitting blades 460. In some embodiments, the splitting blades 460 are attached to the second support members 434. In other embodiments, the splitting blades 460 are formed from the second support members 434 and are formed therein.

As described above, a log is passed from the first end 402 to the second end 404 of the splitter 400 where it is split by the ports 440, 450, and the splitting blades 460. As the logs are split by the ports 440, 450, and the splitting blades 460 sections of the logs are forced away. These sections may be further split by blades on the support members 430 as described below.

The first support members 432 secure the first port 440 and the second port 450 to the frame 405. In the embodiment of the splitter 400 described herein, six first support members 432 are connected between the frame 405 and the first port 440 and the second port 450. More specifically, two first support members 432 are attached to each side of the first port 440. Two first support members 432 are connected to each corner of the second port 450.

Each of the first support members 432 have two blades formed therein. Referring to FIG. 5, a first blade 466 extends between the frame and the first port 440 and a second blade 468 extends between the first port 440 and the second port 460. The blades 466, 468 are tapered in such a way as to force the split sections of the logs away from the splitter 400 in order to prevent them from getting bound up within the splitter 400. An example of this tapering is shown in FIG. 4 with reference to two support members 470 and 472. The taper on the blades 466, 468 on the support member 470 force the split portions of the logs in a direction 474 away from the splitter 400. Likewise, the taper on the blades 466, 468 on the support member 472 causes the split portions of the logs to be forced in a direction 476 away from the splitter 400. Portions of the logs between the support members 470, 472 are therefore less likely to get bound up as they are split because the split portions are not forced into any of the support members 470, 472.

As with the first support members 432, the second support members 434 also have blades formed therein. As shown by a second support member 480 in FIG. 5, the second support members 434 may have three bladed formed therein or attached thereto. A first blade 482 extends from the proximity of the frame 405 to the proximity of the second port 450. The first blade 482 is angled toward the second side 404 of the splitter. A second blade 484 extends from the second blade 482 to the second port 450 and is angled toward the first side 402 of the splitter 400. The third blade 486 extends from the second port 450 to the cutting blades 460. The first blades 482 may further split portions of logs split from the first port 440. The second blades 484 may further split portions of the logs split by the second port 450. The third blades 486 may enhance the splitting of the splitting blades 460 as described below.

Having described the structure of the splitter 400, its operation will now be described. The splitter 400 is mounted to a structure that has a devices used to force logs through the splitter. For example, the structure may have a ramming device, such as a hydraulic piston, forces logs into to the first side 402 of the splitter 400.

A log is forced into the first end 404 of the splitter. More specifically, the log is forced into the opening 406 in the frame 405. In some embodiments, a plurality of logs may be placed end to end. The device that forces the logs into the splitter may force all the logs into the splitter one by one.

As the log enters the opening 406, it encounters the first stage 418. More specifically, the log encounters the first blades 466 on the first support members 432. The first blades 466 start to split the outer portion of the log. Soon after encountering the first blades 466, the log encounters the first port 440. More specifically, the log encounters the blade 444 extending around the periphery of the first port 440. The blade 440 shears the periphery of the log from a center portion of the log, wherein the center portion of the log passes through the first port 440. As the log is passed further into the splitter 400, the first blades 466 continue to split the portions of the log that are not passed through the first port 440. In some embodiments, the first blades 482 on the second support members 434 may further split the portions of the logs that do not pass through the first port 440.

At this point, the log is passing through the first stage 418 and is entering the second stage 420. More specifically, a portion of the log that passed through the first port 440 is entering the second stage 420. The other portions of the log have been sheared away by the blade 440 and are further split by the blades 466, 482. As the log enters the second stage 420 from the first port 440, it encounters the second blades 468 on the first support members 432, which start to split the log further. A central portion of the log passes into the second port 450, where the blade 454, FIG. 7, shears away the peripheral portion of the log. As the log is forced further into the second stage, the peripheral portion is further stripped away and split by the second blades 454. At this time, portions of the peripheral part of the log are also split by the second blades 484 on the second support members 434. As described above, the tapering of the blades forces the split sections away from the splitter 400 so that they do not get bound up in the splitter 400.

A small inner portion of the original log passes through the second port 450 where it is further split by the splitting blades 650 and the third blades 486 on the second support members 434. In the embodiment described herein, the third stage 422 splits the inner portion of the log into four pieces.

By using different stages to split the logs, less force is required to split the logs than used by conventional splitters. For example, the peripheral portion of the log is sheared away after the log leaves the first stage 418. The inner portion of the log that passes through the first port 440 is split as it enters the second stage 420. Thus, the device used to force the logs into the splitter 400 does not have to force a split of the entire log. Rather, it has to force portions of the log to be split as the log is forced into the splitter.

In addition, the splitting stages are staggered, so the blades on the support members 430 are angled. This angling enables a slower splitting of the logs. For example, as a log encounters the second blades 468 on the second support members 432, the portion of the blade closest the first port 440 encounters the log and commences the splitting process. As the log is further forced into the splitter, the remaining portions of the second blades 468 split the logs. Accordingly, the logs are not split in a single action.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A log splitter comprising:
a first stage comprising:
a first port having a circumference, wherein at least one blade is located on said circumference, wherein said at least one blade shears a log as said log is forced through said first port;
at least one blade located exterior to said first port, wherein a portion of said log not passing through said first port is split by said at least one blade;
a second stage comprising:
a second port having a circumference, wherein a portion of the log exiting said first port is receivable in said second port, wherein at least one blade is located on said circumference of said second port, and wherein said at least one blade shears the portion of said log passing through said second port;
at least one blade located exterior to said second port, wherein a portion of said log not passing through said second port is split by said at least one blade.

2. The log splitter of claim 1, wherein at least one of said blades located on the circumference of said first port is tapered, the taper forcing portions of the log that do not pass through said first port away from said first port.

3. The log splitter of claim 1, wherein at least one of said blades located on the circumference of said second port is tapered, the taper forcing portions of the log that do not pass through said second port away from said second port.

4. The log splitter of claim 1, wherein at least one of said blades located exterior to said first port is tapered, the taper forcing portions of the log that are split by at least one of said blades away from said first stage.

5. The log splitter of claim 1, wherein at least one of said blades located exterior to said second port is tapered, the taper forcing portions of the log that are split by at least one of said blades away from said second stage.

6. The log splitter of claim 1, wherein at least one of said blades located exterior to said second port extends between a location proximate said first port and a location proximate said second port.

7. The log splitter of claim 6, wherein said logs entering said second stage contact said at least one blade located exterior to said second port before contacting said second port.

8. The log splitter of claim 1, wherein said first port has an entrance and an exit, wherein logs enter said entrance and wherein said second port is located a distance from said exit, and wherein said at least one blade located exterior to said first port extends in front of said entrance so that logs entering said first stage contact said at least one blade before contacting said first port.

9. The log splitter of claim 1 and further comprising a third stage, said third stage comprising at least one blade, wherein logs enter said third stage from said second stage, and wherein logs entering said third stage are split by said at least one blade.

10. The log splitter of claim 9 and further comprising at least one blade extending between a location proximate said second stage and a location proximate said third stage.

11. The log splitter of claim 9, wherein said at least one blade of said third stage comprises a first blade that bisects a second blade.

12. The log splitter of claim 1 wherein one blade located exterior to said first port and one blade located exterior to said second port are formed on a single piece of material.

13. The log splitter of claim 12, wherein said single piece of material is affixed to said first port and said second port.

14. The log splitter of claim 1 and further comprising at least one blade extending between said first stage and said second stage.

15. The log splitter of claim 1 wherein at least one of the blades located exterior to said second port extends in a direction away from said first port.

16. The log splitter of claim 1 and further comprising a frame located in front of said first port, wherein logs pass through said frame before entering said first port.

17. The log splitter of claim 16, wherein said at least one blade located exterior to said first port extends between a location proximate said frame and a location proximate said first port.

18. The log splitter of claim 16, wherein one blade located exterior to said first port and one blade located exterior to said second port are formed on a single piece of material extending between said frame and said third second port.

19. The log splitter of claim 1 and further comprising:
a third stage comprising at least one blade, wherein logs enter said third stage from said second stage, and wherein logs entering said third stage are split by said at least one blade; and
at least one support member extending between said frame and said third stage.

20. The log splitter of claim 19, wherein said at least one support member has a plurality of bladed formed therein.
